(19) United States
(12) Patent Application Publication
(10) Pub. No.: US 2007/0207501 A1
(43) Pub. Date: Sep. 6, 2007

(54) Evaluation of the performance profile of catalysts

(75) Inventors: Dorit Wolf, Oberursel (DE); Steffen Seebald, Kahl Am Main (DE); Thomas Tacke, Alzenau (DE)

Correspondence Address: VENABLE LLP, P.O. BOX 34385, WASHINGTON, DC, 20043-9998, US

(73) Assignee: Degussa AG, Dusseldorf (DE)

(21) Appl. No.: 11/651,582

(22) Filed: Jan. 10, 2007

(30) Foreign Application Priority Data
Mar. 6, 2006 (EP) EP06110693

(51) Int. Cl. C40B 40/04; C40B 50/02

(52) U.S. Cl. 435/7.1

(57) ABSTRACT

A searchable library of catalysts, wherein each catalyst is defined by a specific performance profile, is created by a series of steps. The first involves the selection of a catalyst, a substrate and at least two different chemical reactions for catalyst characterization. The next involves contacting the catalyst and substrate under conditions suitable for the selected reaction and measuring for each of the selected reactions a reaction parameter, which is associated with catalyst performance. The catalyst performance is then determined and a value assigned. The performance profile is a table including the performance values. The catalyst is then placed into a library, which is searchable based on the performance profile.

### BACKGROUND OF THE INVENTION

1. Field of Invention

The subject of the invention is a library of catalysts, a method to produce the library and a method to elect a catalyst.

2. Description of Related Art

The development of heterogeneous catalysts is related to the challenge that solid properties determining the catalytic properties are not easily accessible. This is especially true for fine tuning of selectivity and long-term catalytic stability where gradual changes by 1% are already of importance. Regardless the fact that catalysts do not show obvious differences with respect to solid properties (e.g. metal particle size, particle dispersion or solid phase and oxidation state of the active metal) they often reveal differences in their catalytic behaviour. An additional challenge in catalyst development is related to the complex dependency between solid properties themselves. This may lead to the situation that particular properties cannot be changed independently without influencing others being also important for catalytic performance (e.g., the simultaneous change of metal particle size together with the change of their radial distribution on the support or the simultaneous change of metal oxidation state together with the change of dispersion etc.)

For industrial application of catalysts in fine chemistry these circumstances are serious obstacles for a straightforward rational development and the identification of suitable catalysts for conversion of certain substrates.

Therefore there was the problem to find a method to find a catalyst showing the performance profile promising the best effort.

### BRIEF SUMMARY OF THE INVENTION

Subject of the invention is a catalyst, characterized in that, it is defined by a specific performance profile.

In a preferred subject of the invention the catalyst is a heterogeneous catalyst.

The performance profile of the catalyst can be estimated, whereby the catalyst is first synthesized and then used in at least two different chemical reactions assigned to various chemical reaction classes comprising preferentially

hydrogenation of carbonyl compounds
hydrogenation of olefins or polyolefins
hydrogenation of aromatics or heteroaromatics
hydrogenation of nitro-compounds
hydrogenation of nitriles,
hydrogenation of imines,
hydrogenation of hydroxylamines,
hydrogenation of alkynes,
reductive alkylation of primary or secondary amines, reductive amination of aldehydes or ketones by ammonia salts or by amines,
hydrogenolysis of C—C bonds, ethers, carbamates, carbonates, amines or organic sulfides,
hydrodehalogenation of halo-aromatics or halo-aliphatics,
dehydrogenation of cycloalkanes or cycloalkenes,
isomerization of hydroxy-olefins,
hydrogenation of multifunctional substrates including at least two of the following functional groups or structural units: CC-double bond CC-triple bond, nitro-, alcohol-, carbonyl-, carboxyl-, nitril-, imine, hydroxylamine-, azo-, diazo-, halogen-, ether-group, aromatic rings,
oxidation of alcoholes,
oxidation of aldehydes,
oxidation of olefins,
oxidation of multifunctional substrates including at least two of the following functional groups:

### CC-double bond, CC triple bond, alcohol-, carbonyl-, nitril-, imine, hydroxylamine-, azo-, diazo-group,

### C—C coupling,

enantioselective hydrogenation of carbonyl compounds,
enantioselective reductive alkylation of primary or secondary amines,
enantioselective reductive amination of aldehydes or ketones by ammonia salts or by amines,
whereby in respect to each reaction the catalyst performance is estimated and correlated to a defined table in order to set up the performance profile.

The defined table for the correlation of the performance of the catalyst may be a table, in which the different reaction types are noted in a specific sequence.

In a preferred subject of the invention the sequences of the reaction types, which is noted in the specific sequence in the table, can be chosen from at least two different reaction types selected from the group

hydrogenation of carbonyl compounds
hydrogenation of olefins or polyolefins
hydrogenation of aromatics or heteroaromatics
hydrogenation of nitro-compounds
hydrogenation of nitriles,
hydrogenation of imines,
hydrogenation of hydroxylamines,
hydrogenation of alkynes,
reductive alkylation of primary or secondary amines,
reductive amination of aldehydes or ketones by ammonia salts or by amines,
hydrogenolysis of C—C bonds, ethers, carbamates, carbonates, amines or organic sulfides,
hydrodehalogenation of halo-aromatics or halo-aliphatics,
dehydrogenation of cycloalkanes or cycloalkenes,
isomerization of hydroxy-olefins,
hydrogenation of multifunctional substrates including at least two of the following functional groups or structural units: CC-double bond CC-triple bond, nitro-, alcohol-, carbonyl-, carboxyl-, nitril-, imine, hydroxylamine-, azo-, diazo-, halogen-, ether-group, aromatic rings,
oxidation of alcoholes,
oxidation of aldehydes,
oxidation of olefins,
oxidation of multifunctional substrates including at least two of the following functional groups:

### CC-double bond, CC triple bond, alcohol-, carbonyl-, nitril-, imine, hydroxylamine-, azo-, diazo-group,

### C—C coupling,

enantioselective hydrogenation of carbonyl compounds,
enantioselective reductive alkylation of primary or secondary amines,
enantioselective reductive amination of aldehydes or ketones by ammonia salts or by amines.

A further subject of the invention is a library of catalysts, characterised in, that each catalyst is defined by a specific performance profile.

In a preferred form of the invention the library can be searched by using an algorithm of the statistical similarity analysis.

The library can consist of homogeneous and/or heterogeneous catalysts. Preferred are heterogeneous catalysts.

A further subject of the invention is a method to produce the library of catalysts, characterized in, that each catalyst is synthesized separately and then used in at least two different chemical reactions assigned to various chemical reaction classes comprising preferentially

hydrogenation of carbonyl compounds,
hydrogenation of olefins or polyolefins,
hydrogenation of aromatics and heteroaromatics,
hydrogenation of nitro-compounds,
hydrogenation of nitriles,
hydrogenation of imines,
hydrogenation of hydroxylamines,
hydrogenation of alkynes,
reductive alkylation of primary or secondary amines,
reductive amination of aldehydes or ketones by ammonia salts or by amines,
hydrogenolysis of C—C bonds, carbamates, carbonates, ethers, amines or organic sulfides,
hydrodehalogenation of haloaromatics or haloaliphatics,
dehydrogenation of cycloalkanes or cycloalkenes,
isomerization of hydroxy-olefins,
hydrogenation of multifunctional substrates including at least two of the following functional groups or structural units: CC-double bond CC-triple bond, nitro-, alcohol-, carbonyl-, carboxyl-, nitril-, imine, hydroxylamine-, azo-, diazo-, halogen-, ether-group, aromatic rings,
oxidation of alcohols,
oxidation of aldehydes,
oxidation of olefins,
oxidation of multifunctional substrates including at least two of the following functional groups:

### CC-double bond, CC-triple bond, alcohol-, carbonyl-, nitril-, imine, hydroxylamine-, azo-, diazo-group,

### C—C coupling,

enantioselective hydrogenation of carbonyl compounds,
enantioselective reductive alkylation of primary or secondary amines,
enantioselective reductive amination of aldehydes or ketones by ammonia salts or by amines,
whereby in respect each reaction the catalyst performance is estimated and correlated to a defined table in order to set up the performance profile, further on the catalyst is put into the library.

A further subject of the invention is a method to elect a catalyst from the library in respect to a given substrate, which is characterised in, that the substrate, which should be treated with the catalyst, can produce a plurality of compounds, whereby one specific compound is wanted to be produced selectively, whereby the substrate shows a specific profile in respect to the performance of the catalyst needed and this performance profile is compared to the performance profiles of the library according to the invention.

This election can be performed by using algorithm of the statistical similarity analysis.

The substrate according to the invention can be any chemical compound, which owns the structure and/or reactive groups that can undertake at least one reaction assigned to various chemical reaction classes comprising preferentially

hydrogenation of carbonyl compounds
hydrogenation of olefins or polyolefins
hydrogenation of aromatics or heteroaromatics
hydrogenation of nitro-compounds
hydrogenation of nitriles,
hydrogenation of imines,
hydrogenation of hydroxylamines,
hydrogenation of alkynes,
reductive alkylation of primary or secondary amines,
reductive amination of aldehydes or ketones by ammonia salts or by amines,
hydrogenolysis of C—C bonds, ethers, carbamates, carbonates, amines or organic sulfides,
hydrodehalogenation of halo-aromatics or halo-aliphatics,
dehydrogenation of cycloalkanes or cycloalkenes,
isomerization of hydroxy-olefins,
hydrogenation of multifunctional substrates including at least two of the following functional groups or structural units: CC-double bond CC-triple bond, nitro-, alcohol-, carbonyl-, carboxyl-, nitril-, imine, hydroxylamine-, azo-, diazo-, halogen-, ether-group, aromatic rings,
oxidation of alcoholes,
oxidation of aldehydes,
oxidation of olefins,
oxidation of multifunctional substrates including at least two of the following functional groups:

### CC-double bond, CC triple bond, alcohol-, carbonyl-, nitril-, imine, hydroxylamine-, azo-, diazo-group,

### C—C coupling,

enantioselective hydrogenation of carbonyl compounds,
enantioselective reductive alkylation of primary or secondary amines,
enantioselective reductive amination of aldehydes or ketones by ammonia salts or by amines.

According to the invention the method (so called “catalytic performance profiling”) was developed with which catalytic characteristics of heterogeneous catalysts for fine chemical application can be efficiently and comprehensively elucidated. Moreover, those physical properties can be identified, which do influence the catalytic performance profiles significantly. Thus, the profiling method according to the invention takes into account the complex relationship of physico-chemical parameters of solids and catalytic performance parameters

### BRIEF DESCRIPTION OF THE SEVERAL VIEWS OF THE DRAWINGS

FIG. 1 a) and b) show an illustration of the concept for catalyst profiling based on a set of sensitive test reactions.

FIG. 2 shows the catalytic performance profiles of four Pd(5-wt %)/C catalysts.

FIG. 3 shows the solids' characteristics profiles.

FIG. 4 shows a series of similarity plots for characterization profiles and for catalytic performance profiles involving DEG-cat 1, DEG-cat 2, DEG-cat 3, and DEG-cat 4.

FIG. 5 shows a reaction scheme which leads to selective formation of saturated alcohol.

FIG. 6 shows performance profiles of real catalysts.

FIG. 7 shows the ideal performance profile.

FIG. 8 shows the ranking of similarity of the sixteen Pd catalysts with respect to the hypothetical ideal profile shown in FIG. 7. Catalyst DEG-3 appears to be the preferable catalyst for the selective hydrogenation of hydroxy-olefin. DEG-16, DEG-14 and DEG-12 are expected to give also high yield of the saturated alcohol.

FIG. 9 shows a plot of the yield of saturated alcohol obtained by conversion of the 1-hydroxy-3,4-olefin versus the similarity values derived from the Euclidean distance between performance profiles of real catalysts and the ideal profile. The correlation is significant. The catalytic performance profiling appears to be a fast and unerring method for pre-selection of catalysts for hydrogenation of multi-functional substrates.

FIG. 10 shows catalyst DEG 5 as having excellent and unique catalytic performance for the selective hydrogenation of multiple C═C double bonds and the selective hydrogenation of Cl-nitro-aromatics. Therefore, it is the preferred catalysts for hydrogenation of multi-functional substrates comprising Cl-substituted nitro-aromatics as well as C═C double bonds.

FIG. 11 shows a catalytic performance profile where similarity to average is plotted against similarity to average rank.

### BRIEF DESCRIPTION OF THE INVENTION

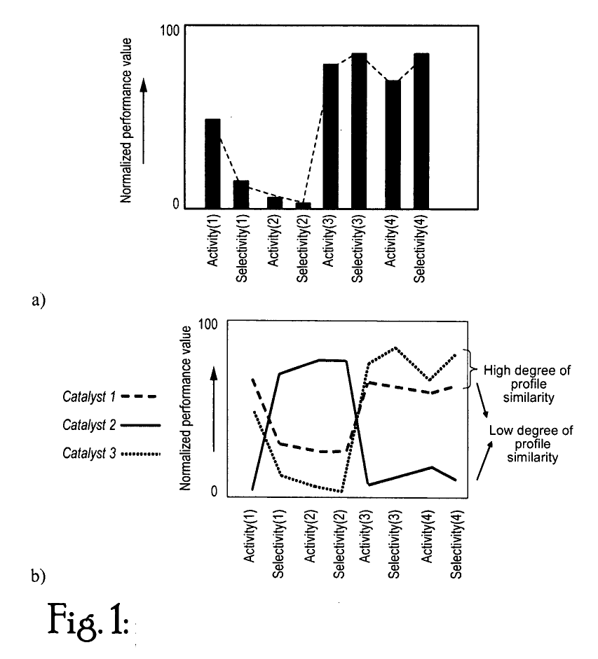

In FIG. 1 a) and b) the principles of catalytic profiling analysis according to the invention are explained:

Catalytic profiling analysis includes a set of test reactions which are very sensitive with respect to catalyst properties and/or the recipes of preparation. These test reactions are numbered by 1, 2, 3 and 4.

From activity and selectivity values measured for test reactions 1, 2, 3 and 4 (FIG. 1a) corresponding performance profiles (FIG. 1b)) can be derived which can be understood as catalytic fingerprints for individual catalysts 1, 2 and 3. Thus, performance profiles allow a statistical analysis of similarities (FIG. 1b).

At this point it has to be emphasized that for statistical similarity analysis a large population of catalysts is necessary in order to cover a sufficient number and scale of performance parameters (activities, selectivities in the different reactions). The scale of performance values is a relative one. I. e. the maximum value of a particular performance value in the test population was set to 100%, while the minimum value was set to 0. Thus, the scale is rather flexible and will certainly change with increasing the test population of catalysts.

A procedure similar to the catalytic performance profiling is applied to profiling of solids' characteristics. Hereby, measurable solid properties (e.g. metal particle size, metal dispersion, binding energies of elements of noble metals or oxygen, pore size distribution of supports etc.) are summarized in solids' characteristics profiles followed by statistical similarity analysis.

According to the state of the art heterogeneous catalysts are developed for certain application by correlating the catalytic performance in a certain reaction with parameters of catalyst composition and preparation as well as by characterizing physico-chemical properties of the catalyst and correlates them with parameters of preparation and catalytic performance (so called knowledge-based rational approach). I. e. a certain catalyst will be optimised for a certain reaction and a certain substrate.

In contrast, the catalytic profiling method according to the invention is a heuristic method which takes into account for the complexity of the relationship between catalyst preparation method and catalytic performance in a large diversity of classes of reactions of (multi-functional) substrates. For this purpose catalytic tests with a variety of reactions are performed. The particular performance values of the catalytic reactions are summarized by the catalytic performance profiles. This approach leads to a unique fingerprint for individual catalysts allowing a fast identification of strength and weaknesses of a catalyst.

Based on this libraries of heterogeneous catalysts according to the invention are built up, which cover a wide range of fine-chemical application of solid catalysts from which suitable catalysts can be chosen rapidly.

Based on the profiling method according to the invention catalysts are unambiguously characterized. Based on the profiling analysis according to the invention catalyst preparation methods can be rapidly optimised with respect to production costs (substitution of complicated preparation methods by easier ones, substitution of expensive raw material by cheaper ones, fast scale-up of catalyst production methods up to technical scale . . . ).

Based on profiling analysis according to the invention the preferred field of catalyst application (class of reaction and particular substrate) can be much faster identified than with the conventional approach of catalyst development for single reactions. This leads to a significant acceleration of development of heterogeneous catalytic processes.

### EXAMPLE 1

This example demonstrates that the characterization and optimisation of catalysts for fine-chemical applications, based on catalytic tests is much more informative and more efficient than characterizing physico-chemical properties of catalysts and correlating them with catalytic properties as done for development of heterogeneous catalysts according to the state of the art.

The profiling methodology was validated for four Pd (5 wt-%)/C powder catalysts, prepared by different methods and showing different metal particle size, metal dispersion and oxidation state of Pd. All catalysts were based on the same activated carbon support. Hence, support properties were neglected in the analysis.

For catalytic profiling analysis four different hydrogenation reactions were considered. These included hydrogenation of Cl-nitrobenzene, dibenzylether, cinnamic acid and selective hydrogenation of a 1-hydroxy-3,4-olefin. From these four test reactions the following twelve catalytic performance criteria were derived as basis of catalytic performance profiles:

### Hydrogenation of Cl-nitrobenzene at 10 Bars and 25° C.

### (1) Activity for hydrogen conversion at reaction t=0

### (2) Selectivity with respect to Aniline at complete conversion of substrate

### (3) Selectivity with respect to Cl-Aniline at complete conversion of substrate

### Hydrogenation of Dibenzylether at 10 Bars and 25° C.

### (6) Activity for hydrogen conversion at reaction time=0

### (7) Activity for hydrogen consumption at reaction time t=80 min

### (8) Total hydrogen consumption at reaction time t=80 min

### Hydrogenation of Cinnamic Acid at 10 Bars and 25° C.

### (9) Activity of hydrogen consumption at reaction time t=0

### Hydrogenation of a 1-hydroxy-3,4-olefin at 10 bars and 70° C.

### (10) Selectivity to the hydroxy alkane at complete conversion of substrate

### (11) Selectivity to the ketone at complete conversion of substrate (formed by isomerization)

### (12) Selectivity to the alkane at complete conversion of substrate (formed by double bond hydrogenation and hydrogenolysis of OH group)

For physical characteristics profiles the following eighteen values derived from statistical analysis of TEM data and XPS analysis were used:

(1) asymmetry of particle size distribution referring to metal particle number
(2) asymmetry of particle size distribution referring to metal particle volume
(3) inconsistency of particle size distribution referring to metal particle number
(4) inconsistency of particle size distribution referring to metal particle volume
(5) kurtosis of particle size distribution referring to metal particle number
(6) kurtosis of particle size distribution referring to metal particle volume
(7) mean volume of metal particles/nm³
(8) metal particle size distribution referring to metal particle number/nm
(9) particle size distribution referring to metal particle volume/nm
(10) relative standard deviation of metal particle size distribution referring to metal particle number/%
(11) relative standard deviation of metal particle size distribution referring to volume/%
(12) specific surface area of metal particles/m² cm⁻³
(13) standard deviation of metal particle size distribution referring to metal particle number/nm
(14) standard deviation of metal particle size distribution referring to metal particle volume/nm

### (15) XPS Binding energy derived from the Pd 3d 5/2 signal

### (16) XPS Binding energy of derived from the 0 is signal

(17) surface atom fraction of palladium (derived from XPS analysis)
(18) surface atom fraction of oxygen (derived from XPS analysis)

For the experimental tests a eightfold batch reactor system (reactor volume 20 ml) with magnetic stirring, which allows the measurement of hydrogen uptake at constant hydrogen pressure was used. Analysis of substrates and products was performed off-line by GC for determining selectivity values. Activity values were derived from hydrogen up-take within a defined time interval.

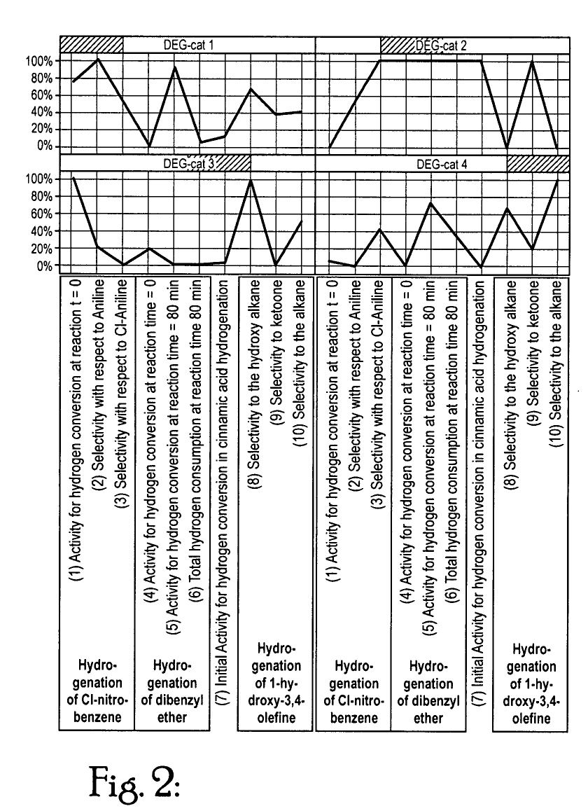

FIG. 2 shows the complete catalytic performance profiles for the four different catalysts;

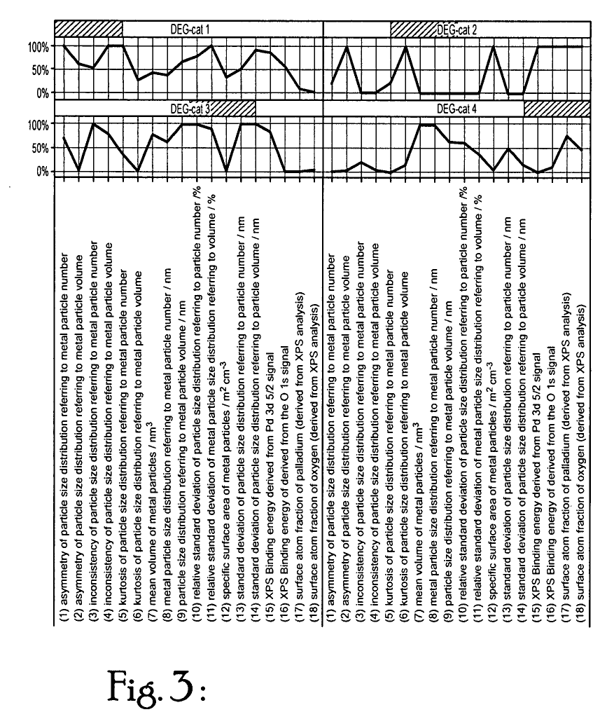

FIG. 3 indicates the profiles of physical characteristics. (The sequence of profiling parameters from left to right corresponds to that mentioned above.)

The catalytic performance profiles of the four Pd/C catalysts look rather different (FIG. 2). Similarities are not obvious despite the catalysts have the same Pd loading (5 wt-%) and the same activated carbon support. Thus, the differences in the catalytic behaviour are exclusively determined by the different modes of preparation.

The strongest differences in catalytic behaviour can be derived for samples DEG-cat 2 and DEG-cat 3. While DEG-cat 2 is highly active for debenzylation, cinnamic acid formation and selective for formation of Cl-aniline, DEG-cat 3 shows low activity for debenzylation and cinnamic acid formation as well as low selectivity in Cl-aniline formation. DEG-cat 1 and DEG-cat 4 are in-between of the catalytic performance profiles of DEG-cat 2 and DEG-cat 3.

In contrast to the catalytic performance profiles the comparison of profiles of solids' characteristics indicates similarities for DEG-cat 1 and DEG-cat 3 while for DEG-cat 2 and DEG-cat 4 no obvious similarities can be derived (FIG. 3).

In order to rationalize the comparison of profiles a statistical similarity analysis was performed based on Pearson Product Momentum Correlation where profiles with identical shape have maximum correlation and perfectly mirrored profiles have minimum correlation [Hair, J. F. Jr., Anderson, R. E., Tatham, R. L., Black, W. C. (1995) Multi-variate Data Analysis, Fourth Edition, Prentice Hall, Englewood Cliffs, N.J.].

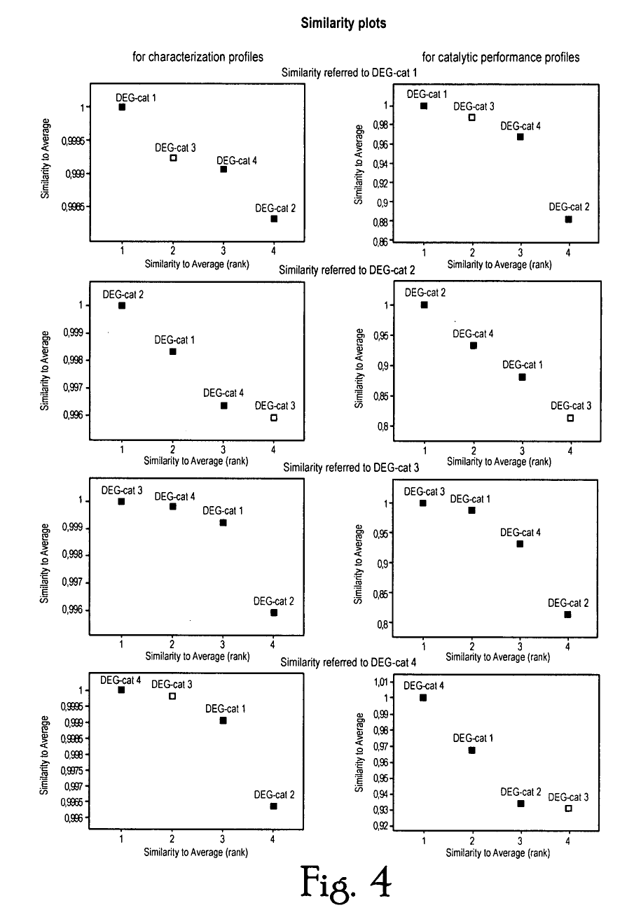

In FIG. 4 the results of statistical similarity analysis are summarized for both the solids profiles (left hand side) and the catalytic performance profiles (right hand side) by plotting the similarity measure versus similarity rank. Hereby, each of the four catalyst samples was chosen ones as master to whom the similarity of the residual three catalysts was referred. The symbol of the “master” catalyst is located in the upper left corner of each figure (highest similarity value (=1) and lowest rank with respect to similarity (=1)).

It can be seen that there is no complete agreement in the plots for solids' characteristics profiles and catalytic performance profiles since the similarity with respect to solids' characteristics between DEG-cat 1 and DEG-cat 3 is close while it is not for the catalytic performance profiles. From this finding it can be concluded that some of the test reactions are probably influenced by solid properties which have yet not been covered by the solids parameters.

Thus, catalytic profiling is a more sensitive indicator for modifications of preparation methods than profiling of physical properties. Catalytic profiling is an efficient and effective method for optimisation and development of catalysts for fine-chemical application.

### EXAMPLE 2

The example demonstrates that a data base comprising activity data from hydrogenation of mono-functional substrates allows a pre-selection of potential catalysts for hydrogenation of multifunctional substrates. Based on this pre-selection concept the process of identifying the optimal precious metal powder catalysts is accelerated.

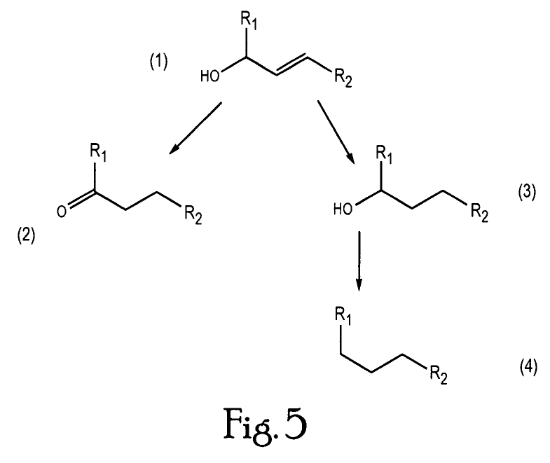

A catalyst which leads to selective formation of saturated alcohol according to reaction scheme in FIG. 5 shall be identified among a group of sixteen different Pd-catalysts prepared by different methods and showing different metal particle size, metal dispersion and oxidation state of Pd. For pre-selection of promising catalysts, profiling data concerning C═C double bond hydrogenation and hydrogenolysis are of interest.

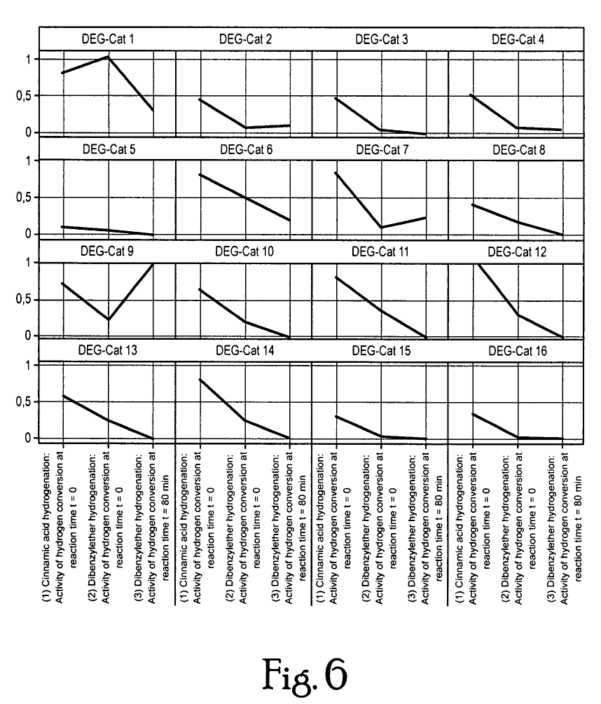

Activity data for hydrogenation of cinnamic acid which represents C═C double bond hydrogenation and debenzylation of debenzylether which represents hydrogenolysis were chosen as pre-selection criteria and visualized by performance profiles (FIG. 6). The profiles refer to the following activity values:

Hydrogenation of cinnamic acid at 10 bars and 25° C.
(1) Activity of hydrogen conversion at reaction time t=0

Hydrogenation of dibenzylether at 10 bars and 25° C.
(2) Activity for hydrogen conversion at reaction time t=0
(3) Activity for hydrogen conversion at reaction t=80 min

For the activity tests a eightfold batch reactor system (reactor volume 20 ml) with magnetic stirring which allows the measurement of hydrogen uptake at constant hydrogen pressure was used. Analysis of substrates and products was performed off-line by gaschromatography for determining selectivity values. Activity values were derived from hydrogen up-take within a defined time interval.

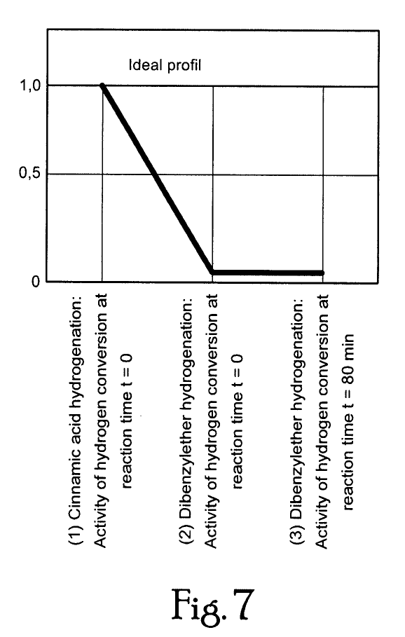

Catalysts which are expected to be highly selective in the hydrogenation of hydroxy-olefin (FIG. 5) should reveal high activity in C═C-double bond hydrogenation but low activity in hydrogenolysis. Accordingly, a hypothetical performance profile can be drawn which reflects an ideal catalyst revealing highest activity in C═C-double bond hydrogenation and zero activity in the hydrogenolysis as shown in FIG. 7. Now, the profiles of the real catalysts shown in FIG. 6 can be compared with the hypothetical ideal profile based on statistical similarity analysis. Those of the sixteen different Pd catalysts in FIG. 6 which are most similar to the hypothetical profile should correspond to the preferable catalysts for selective hydrogenation of the hydroxy-olefin shown in FIG. 5.

The statistical similarity analysis was performed based on determination of Euclidean distance between hypothetical and catalyst profile according to the following formula:

$$similarity = \sqrt{\frac{{( real perfomance value - ideal performance value )}^{2}}{{( ideal performance value )}^{2}}}$$

Since relative distances are considered in this formula small positive deviations from zero-activity for the hydrogenolysis are strongly weighted.

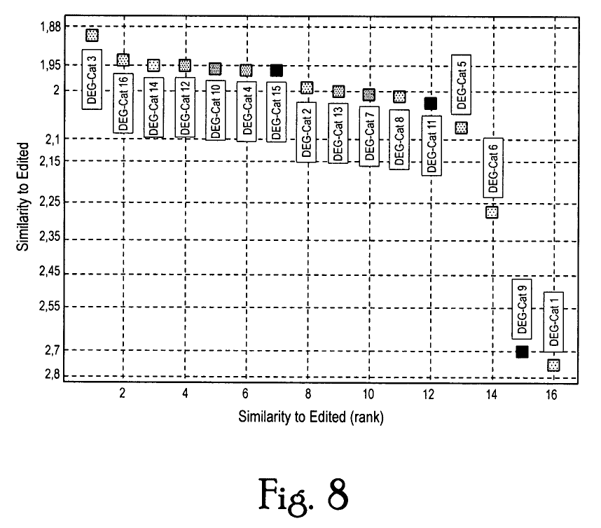

FIG. 8 indicates the ranking of similarity of the sixteen Pd catalysts with respect to the hypothetical ideal profile shown in FIG. 7. Accordingly, catalyst DEG-3 appears to be the preferable catalyst for the selective hydrogenation of hydroxy-olefin. DEG-16, DEG-14 and DEG-12 are expected to give also high yield of the saturated alcohol.

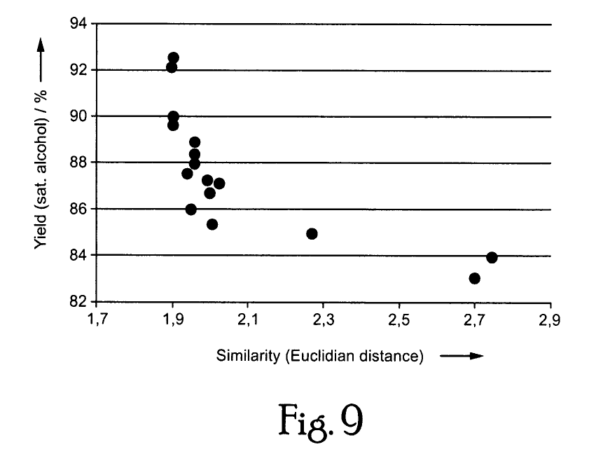

The proof that this pre-selection meets indeed the most selective catalysts for the hydrogenation of the hydroxy-olefin is derived from FIG. 9. There, the yield of saturated alcohol obtained by conversion of the 1-hydroxy-3,4-olefin (see FIG. 5) is plotted versus the similarity values derived from the Euclidean distance between performance profiles of real catalysts (FIG. 6) and the ideal profile (FIG. 7). The correlation between yield and similarity is significant. Therefore, the catalytic performance profiling appears to be a fast and unerring method for pre-selection of catalysts for hydrogenation of multi-functional substrates.

### EXAMPLE 3

This example demonstrates that the profiling method allows a straightforward optimisation of a catalyst preparation method with respect to preparation recipe and, hence, production costs.

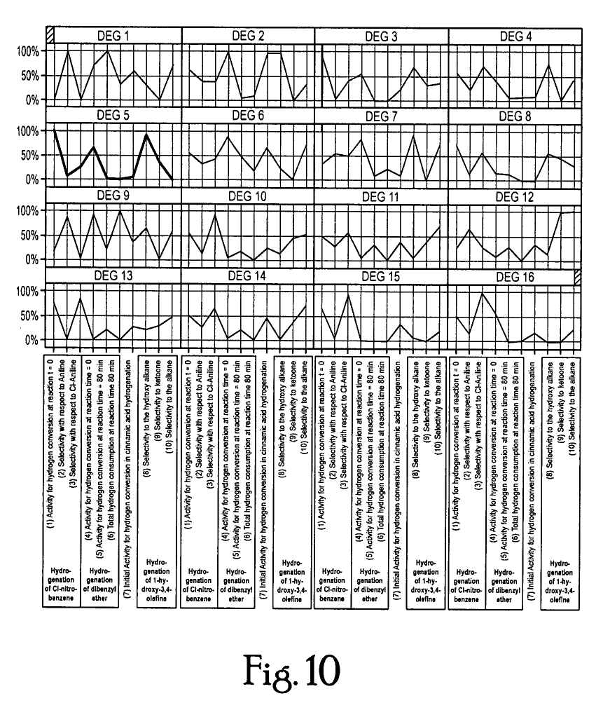

A catalyst DEG 5 (see FIG. 10) shows excellent and unique catalytic performance for selective hydrogenation of multiple C═C double bonds and selective hydrogenation of Cl-nitro-aromatics. Therefore, it is the preferred catalysts for hydrogenation of multi-functional substrates comprising Cl-substituted nitro-aromatics as well as C═C double bonds. The preparation of this catalyst, however, is costly. Fifteen alternative modifications of the DEG-5 preparation method were developed with the aim to maintain the complete catalytic performance profile of the DEG-5 catalyst but to minimize the catalyst production effort. Catalytic performance profiles of theses samples indicated in FIG. 10 refer to the chemical reactions mentioned in Example 1.

For the experimental tests a eightfold batch reactor system (reactor volume 20 ml) with magnetic stirring which allows the measurement of hydrogen uptake at constant hydrogen pressure was used. Analysis of substrates and products was performed off-line by gaschromatography for determining selectivity values. Activity values were derived from hydrogen up-take within a defined time interval.

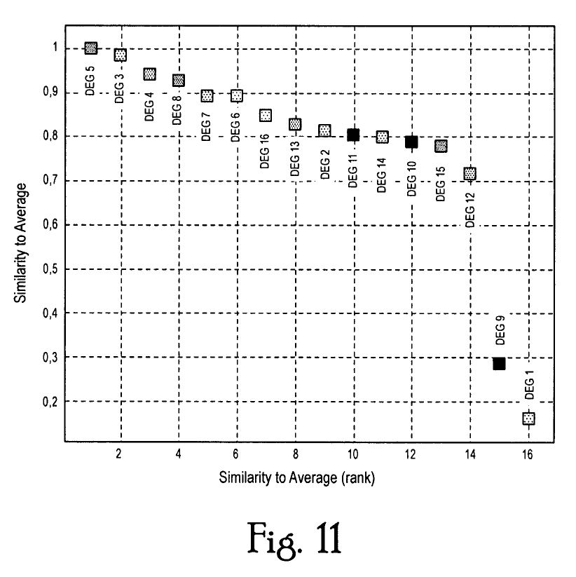

Based on similarity analysis those alternative samples were identified which where approximated to DEG-5 with respect to the catalytic performance profile (FIG. 11).

In this example this is fulfilled by DEG-3. This catalyst was prepared based on a much simpler recipe related to lower expenses for raw material (especially reducing agent) and to saving of production time.

1. (canceled)

2. (canceled)

3. Method for determining a specific performance profile for a catalyst comprising,
a) selecting the catalyst substrate and at least two different chemical reactions for determination from:
hydrogenation of carbonyl compounds
hydrogenation of olefins or polyolefins
hydrogenation of aromatics or heteroaromatics
hydrogenation of nitro-compounds
hydrogenation of nitrites,
hydrogenation of imines,
hydrogenation of hydroxylamines,
hydrogenation of alkynes,
reductive alkylation of primary or secondary amines,
reductive amination of aldehydes or ketones by ammonia salts or by amines,
hydrogenolysis of C—C bonds, ethers, carbamates, carbonates, amines or organic sulfides,
hydrodehalogenation of halo-aromatics or haloaliphatics,
dehydrogenation of cycloalkanes or cycloalkenes,
isomerization of hydroxy-olefins,
hydrogenation of multifunctional substrates having at least two of the following functional groups or structural units: CC-double bond CC-triple bond, nitro-, alcohol-, carbonyl-, carboxyl-, nitril-, imine, hydroxylamine-, azo-, diazo-, halogen-, ether-group or aromatic rings,
oxidation of alcohols,
oxidation of aldehydes,
oxidation of olefins,
oxidation of multifunctional substrates having at least two of the following functional groups: CC-double bond, CC-triple bond, alcohol-, carbonyl-, nitril-, imine, hydroxylamine-, azo or diazo-group,
C—C coupling,
enantioselective hydrogenation of carbonyl compounds,
enantioselective reductive alkylation of primary or secondary amines,
enantioselective reductive amination of aldehydes or ketones by ammonia salts or by amines,
b) contacting the catalyst and substrate under conditions suitable for the selected reaction,
c) measuring for each of the selected reactions a reaction parameter associated with catalyst performance,
d) estimating and placing the catalyst performance in a table to establish the performance profile.

4. (canceled)

5. (canceled)

6. (canceled)

7. A method for producing a library of catalysts comprising
a) selecting the catalyst, substrate and at least two different chemical reactions for determination from:
hydrogenation of carbonyl compounds
hydrogenation of olefins or polyolefins
hydrogenation of aromatics or heteroaromatics
hydrogenation of nitro-compounds
hydrogenation of nitriles,
hydrogenation of imines,
hydrogenation of hydroxylamines,
hydrogenation of alkynes,
reductive alkylation of primary or secondary amines,
reductive amination of aldehydes or ketones by ammonia salts or by amines,
hydrogenolysis of C—C bonds, ethers, carbamates, carbonates, amines or organic sulfides,
hydrodehalogenation of halo-aromatics or haloaliphatics,
dehydrogenation of cycloalkanes or cycloalkenes,
isomerization of hydroxy-olefins,
hydrogenation of multifunctional substrates having at least two of the following functional groups or structural units: CC-double bond CC-triple bond, nitro-, alcohol-, carbonyl-, carboxyl-, nitril-, imine, hydroxylamine-, azo-, diazo-, halogen-, ether-group or aromatic rings,
oxidation of alcohols,
oxidation of aldehydes,
oxidation of olefins,
oxidation of multifunctional substrates having including at least two of the following functional groups: CC-double bond, CC-triple bond, alcohol-, carbonyl-, nitril-, imine, hydroxylamine-, azo- or diazo-group,
C—C coupling,
enantioselective hydrogenation of carbonyl compounds,
enantioselective reductive alkylation of primary or secondary amines,
enantioselective reductive amination of aldehydes or ketones by ammonia salts or by amines,
b) contacting the catalyst and substrate under conditions suitable for the selected reaction
c) measuring for each of the selected reactions a reaction parameter associated with catalyst performance,
d) estimating and placing the catalyst performance in a table to establish the performance profile.
e) placing the catalyst into the library, which is searchable.

8. A method for selecting a catalyst from the library of catalysts where a desired substrate and reaction can result in multiple products and selectivity is desired comprising selecting a catalyst based on a comparison of a desired performance profile for a substrate with a performance profiled of the catalyst of the library.

9. A method according to claim 8 wherein selection involves an algorithm including statistical similarity analysis.

10. The library of catalysts defined by a specific performance profile obtained by the method of claim 7.

11. The library according to claim 10 wherein the catalysts are heterogeneous catalysts.

12. The catalyst defined by a specific performance profile obtained by the method of claim 8.

13. The catalyst according to claim 12 wherein the catalyst is a heterogeneous catalyst.
